(19) United States
(12) Patent Application Publication
(10) Pub. No.: US 2009/0138560 A1
(43) Pub. Date: May 28, 2009

(54) Method and Apparatus for Automated Record Creation Using Information Objects, Such as Images, Transmitted Over a Communications Network to Inventory Databases and Other Data-Collection Programs

(75) Inventor: James Joseph Stahl, Raleigh, NC (US)

Correspondence Address: JAMES J. STAHL, JR., 5532 HAWTHORNE PARK, RALEIGH, NC, 27613, US

(73) Assignee: James Joseph Stahl Jr, Raleigh, NC (US)

(21) Appl. No.: 11/946,088

(22) Filed: Nov. 28, 2007

(51) Int. Cl. G06F 15/16

(52) U.S. Cl. 709/206

(57) ABSTRACT

A method, process and apparatus for automating software record creation are disclosed. In a preferred embodiment of the present invention, although not limited thereto, the present invention uses a unique email address as a proxy for and to correspond to a specific database table that in turn is associated with a specific user. In the context of an inventory system and this preferred embodiment the present invention enables an information object, such as a photograph, to be captured remotely and transmitted over a communications network to a proxy email address where it is automatically processed into an inventory record on the desired inventory list without the user needing to have any further interaction with the inventory system than the transmission of the object. Additionally, in this preferred embodiment that utilizes email as the transportation method, inclusion filtering is employed to restrict data submission thereby preventing or greatly mitigating false record entries.

### REFERENCES

### U.S. Patent Documents

US Patent Application 20070100713
US Patent Application 20060282342
U.S. Pat. No. 6,678,663 B1
U.S. Pat. No. 5,668,953
U.S. Pat. No. 6,643,687
U.S. Pat. No. 6,654,787
U.S. Pat. No. 7,190,287
U.S. Pat. No. 7,286,815 B2
U.S. Pat. No. 7,113,922
U.S. Pat. No. 7,117,227 B2
U.S. Pat. No. 7,028,075
U.S. Pat. No. 6,230,188

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Technical Field/Field of the Invention

The present invention relates in general to integrating information or data capturing capabilities of devices, for example, cellular telephones equipped to capture images such as photographs and full motion video, cellular phones that can record speech and other sounds or store text, and portable smell detectors that capture olfactory sensor data; and the telecommunications transmittal services available with these devices, notably but not exclusively email services; with computer-based applications for generating, storing and managing software records, for the purpose of automating methods, procedures and apparatus used to collect, categorize, store and manage information objects or similar data, that heretofore contain redundant decision points, require more complex user interactions and are both more time consuming and more prone to lost data. It further relates to using electronically transmitted information objects, for example images and most notably images captured by wireless devices equipped with cameras, combined with associated transmission information such as email addresses, proxy email addresses, mobile identification numbers, electronic serial numbers and IP addresses, or alternatively a menu selection available on the information capture device, that guides the routing of captured information objects or data to a desired software application, such as an inventory database, for the initial purpose of automating the creation of a software record. All or part of said transmission information, or alternatively device menu selection, is used as a proxy for and to identify, correspond to and trigger the opening of a specific list or table within a database application. As with United States Patent Application 20070100713, the present invention specifically, but not exclusively, “ . . . relates to systems and methods of creating and maintaining inventories.” The present invention is a new and useful improvement to current inventory and asset management machines, systems and processes as well as a new means of automating the collection and cataloging of information objects or similar computer data.

2. Background Art/Description of the Problem Solved

As noted in US Patent Applications numbers 20070100713 and 20060282342 there are many computer-based inventory systems in use today. Most inventory systems utilize database or spreadsheet programming to store, organize and sort information. While some of these systems permit the inclusion of a photograph as part of a record; with a record being the information associated with a single item, information which may but does not necessarily include: Item Description, Make, Model, Serial Number, ID Number, Date Purchased, Purchase Price, Value, Bar Code, Location, etc.; and at least one system: US Patent Application 20060282342 “Image-based inventory tracking and reports”, provides for “ . . . using images as a basis for creating and organizing records in an inventory database” (US Patent Application 20060282342, Abstract), none of these prior-art systems are based on nor have the ability to simply and automatically generate a record solely from the transmission and reception of an information object, for example, a photograph emailed from a wireless device equipped with a camera and one or more communication transport capabilities. All prior art methods of inventory recording require multiple user actions upon two or more devices: an information capture device (ICD), for example a bar code reader for capturing bar coded information, a camera for capturing images of tangible items, an olfactory sensor for capturing smells, a sound recorder for capturing speech and other sounds; and an inventory application device (IAD), a computer loaded with an inventory software program, to create and store a record within a specific list or table. The present invention requires user interaction with just a single ICD, for example, a cellular phone equipped with a camera, with no user interaction beyond the capturing and transmission of the information object, in this example a photograph transmitted via email, and in particular no user action with a second device, such as a personal computer or networked server, needed in order to create a new software record. The present invention allows for validation and editing stages before finalizing a record entry; however, these stages are service set up options within the scope of the present invention. The uniqueness of the present invention is that it eliminates the need for the ‘selection’ and ‘moving and transfer’ steps required in prior-art inventory systems, such as those steps detailed in the “Home Inventory software product” referred to in US Patent Application 20060282342. These prior-art inventory system steps force users to repeat the decisions and associated actions already made when, for example, they select and capture information, such as an image, with the intent of recording that information for inventory or similar purposes. The present invention eliminates this decision process repetition and dramatically reduces the number of steps users must take to create new software records by integrating information transport, especially but not exclusively image transport, and inclusion-list filtering techniques that in the email-transport embodiment of the invention, enables “ . . . e-mail received from any source other than one listed in the inclusion list to be discarded as junk” (U.S. Pat. No. 6,654,787, Background of the Invention, Description of Related Art) with software-based inventory tracking and recording systems. Examples of current inventory tracking and recording systems are user-created databases exemplified by the “Home Contents Inventory List” (http://office.microsoft.com/en-us/templates/CT101172541033.aspx?av=ZXL000) and commercial systems such as Liberty Street Software's AssetManage Home Inventory Software (www.libertystreet.com/Asset-Home-inventory.htm). By integrating three widely available capabilities; information object transport via email or other communications transport, plus inclusion filtering, plus inventory or similar application software; the present invention reduces the number of user decision points and user steps to a single set of non-redundant decisions and user actions. A user's decision to capture information, for example take a photograph, and transmit it, for example send it via email to a specific email address, is all the action a user must take to create an inventory record with the present invention. With the present invention it is no longer necessary for the user to access and directly guide an inventory tracking and recording program, or any other database type program, in order to create an inventory or other type of information-storage record.

Two descriptions of prior art: “The creation of a new record in the inventory database is initiated by a user selecting an image to represent an item to be added to the inventory and moving it into the inventory list.” (US Patent Application 20060282342, Description, Summary at [0005]) and “Users can add items to the Inventory in any of three ways: adding a personalized image from an image folder; adding a sample item as a placeholder for a personalized image; or adding an item for which no image is yet available.” (US Patent Application 20060282342, Description, Detailed Description of Embodiments, IV. Inventory Items, Adding an Item at [0044]) demonstrate both the state of prior art and the inefficiencies of prior-art methods of inventory recording and management. Prior methods of creating an inventory record require redundant decisions on the part of users and considerably more user time due to the number of user interactions required. For example, with prior art image-based inventory tracking systems users must complete or cause to be completed a minimum of four (4) distinct steps in order to create a new record in the appropriate inventory database. First, an image must be created, for example a camera is used to take a picture. Second, the image is placed in an image repository, for example a camera is connected to a personal computer and the image is transferred to a folder such as the “My Pictures” folder within most Microsoft Windows operating systems. Third, the computer-based inventory application must be activated, and fourth, the user must select an image and cause it to be moved into the proper list within the inventory application. Data entry to add a new item or create a new database record requires activation or launching of a database application, selection of the appropriate table or inventory list if multiple lists are present or available, and finally manual selection and placement of an image within the table or inventory list, typically executed via a drag-and-drop procedure. The present invention eliminates redundancy and reduces the number of decision points and steps users must complete to create a database record of an item. In one embodiment the present invention completely eliminates the need for users to interact with the computer device on which the inventory database program resides. In another embodiment, a stand-alone or home-based embodiment, the invention requires only that the user's computer device, typically a personal computer, is powered on and the invention's software programming, herein referred to as the Automated Inventory Recording System (AIRS) program, is running along with the user's email client. The user need not personally access the inventory tracking program, i.e. AIRS, to create a new record.

The main problem solved with the invention is that current means of creating lists of records (e.g. inventory lists, asset records, evidentiary information, etc.) rely on: manual input; human or other interaction to initiate scanning, perform file transfers or copy files; or the loading of predefined identification schemes (e.g. bar codes cross-referenced to product numbers, radio frequency identification tags cross-referenced to item numbers, etch). The present invention does not rely on predefined identification schemes. This invention creates a new means of selecting a: specific software application, particularly a database program for storing information; specific listing within an application, for example within a database program the single table corresponding to the desired inventory list in which a set of data composed of one or more information objects is to be entered, for example a photograph and the date it was taken is data meant for “John Smith's” home inventory list; and as significantly the present invention provides the means of receiving information objects from just a defined set of devices, for example the devices used to transmit from a single pre-identified email address, thereby facilitating the exclusion of inappropriate and unwanted record entries.

Accordingly, the machines, methods, systems and computer programs currently in use for inventory management can be significantly enhanced and improved by this invention. Record keeping systems and processes other than traditional inventory and asset management can also be improved with this invention. For example, information and evidence on property damage can be more efficiently recorded by insurance adjusters and the same holds true for collection of crime scene and case information by police and other investigators as well as for the collection of data in scientific studies. The primary benefits of this invention are that it will: introduce a new and improved method of recording and tracking items and information, expand the utility of currently available item-tracking applications, particularly but not exclusively inventory and asset management type applications, and greatly simplify and expedite record entry of images in both image-based and non-image based databases, making processes requiring data collection less cumbersome and therefore more widely and effectively used. Smaller record-keeping requirements or situations, such as a homeowner needing or desiring to create and maintain an inventory list for insurance purposes, may be the initial beneficiaries; however, the present invention has broad applicability to many areas of information capture and storage.

### BRIEF SUMMARY OF THE INVENTION

The object of this invention is to reduce the number of steps a user is required to perform in order to create software-based records composed of information objects or computer data that represents, characterizes, identifies, or other wise helps define an item.

A further object of this invention is to simplify and speed up the creation of records and item lists, specifically but not exclusively inventory and asset listings.

A further object of this invention is to reduce the number of devices a user must interact with in order to generate itemized records within a software program.

A further object of this invention is to eliminate redundant decision points in selecting information used to identify an item for inclusion in a record.

A further object of this invention is to enable the direct transfer and storage of information, particularly images, into databases thereby eliminating the need for and use of information repositories, such as image folders and photograph libraries, as intermediate storage points.

A further object of this invention is to enable users to cause the creation of records from locations remote from the targeted software program where the records are actually created, stored and managed.

A further object of this invention is to enable users to cause records to be created without the user having to directly and repeatedly access the software program that creates, manages and stores records.

A further object of this invention is to use unique email addresses as a proxies for and to specify lists or tables within a software application, that is generally but not exclusively an inventory database program.

A further object of this invention is to use a single unique email address as a proxy for and to specify a software application and to use the user's personal or business email address as a proxy for and to specify the user's list or table within that software application. The single unique email address that is a proxy for the software application is shared by all users of that software application.

A further object of this invention is to automatically transfer emailed information directly to a specific software program and a specific list, table or spreadsheet within that software program.

A further object of this invention is to prevent or mitigate false record entries by utilizing conventional inclusion list filtering or similar filtering schemes to restrict data submission to a software program.

A further object of this invention is to facilitate the documentation, storage and management of evidentiary and investigative information and scientific data.

The present invention is a method and apparatus for automating software record creation using information transmitted over data communications networks and specifically but not exclusively information transmitted as email attachments routed to unique email addresses. The invention generates a unique email address which acts as both a proxy and an access trigger for a user-specific list, table or worksheet within the invention's inventory application software. This invention integrates well-known: electronic devices for capturing information, telecommunications networks, email services, computers, and database application software This invention utilizes plug-ins, macros and other well-understood development and programming methods within a software program referred herein as the Automated Inventory Recording System (AIRS) to achieve the aforementioned integration and objectives.

### BRIEF DESCRIPTION OF THE SEVERAL VIEWS OF THE DRAWINGS

FIG. 1 illustrates eight steps a user makes with prior art inventory tracking systems that incorporate the use of an image as part of a record entry or as the basis for record creation. It also shows that a user must physically interact with two separate devices, an information capture device (ICD) and an information application device (IAD).

FIG. 2 illustrates the affects of the present invention on the image-centric inventory system demonstrated in FIG. 1: reducing from 8 to three the number of steps required of users in order to create an inventory record, and requiring the user to physically interact with just a single device, the ICD, in the process of creating a record.

FIG. 3 illustrates one embodiment of the invention.

FIG. 4 illustrates the user steps at the ICD of one embodiment of the invention.

FIG. 5 illustrates the computer processing steps within the IAD of one embodiment of the invention.

FIG. 6 illustrates the computer processing steps within the LAD for performing record validation with one embodiment of the invention.

FIG. 7 illustrates the initial service set up process of the invention.

FIG. 8 illustrates the functional elements of one embodiment of the invention

### DETAILED DESCRIPTION OF THE INVENTION

The present invention employs well-known components such as: cell phones and other wireless devices equipped with cameras, voice recorders and GPS capabilities; wireless and wired communications networks including internet and email services; email software and inclusion list filtering; internet browsers; personal computers and servers; database application software; plug-ins; macros, software programming and the like. Presenting the details of all these well-known components and elements is not necessary to obtaining a complete understanding of the present invention as persons of ordinary skill in each relevant art, science or area will on review of the description of the invention understand the relevant component's operation and details.

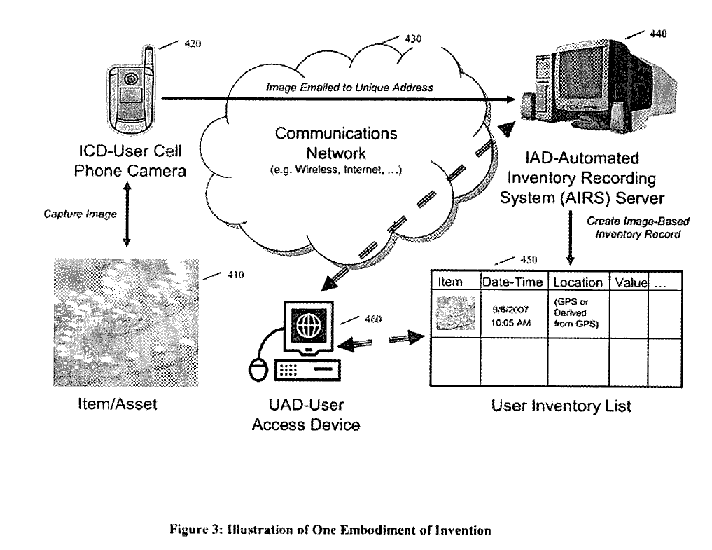

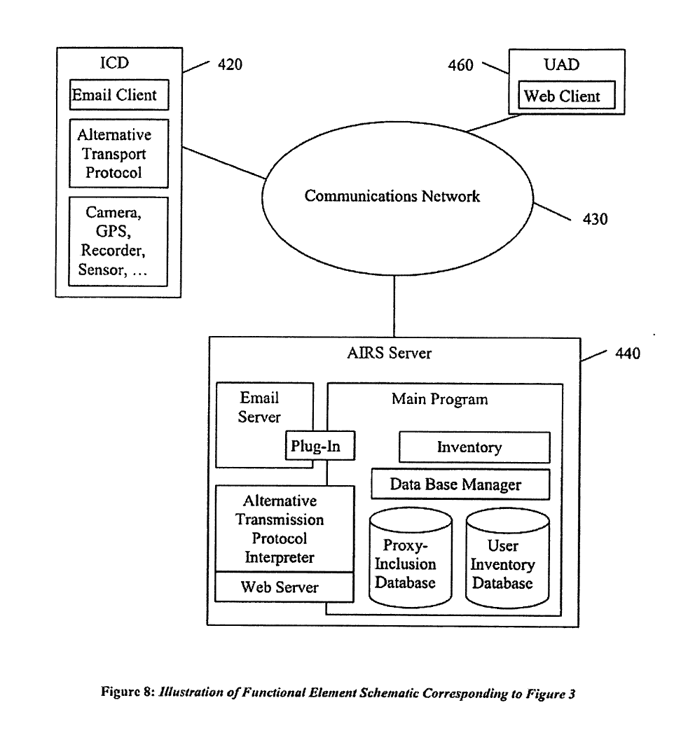

FIGS. 3 and 8 illustrate one embodiment of the invention, an embodiment that illustrates the invention with a photographic image being the information object that is the basis of a new software record. Item 410 is any object that a user desires to record in an inventory record. In the FIG. 3 illustration a string of pearls is used to represent all image-recordable objects. In other embodiments of the invention Item 410 may be a smell, a voice or sound or GPS (global positioning system) data or other information that can be electronically captured, stored and transmitted, specifically but not exclusively, via email. Communication protocols other than email can be employed by this invention and will be discussed later in this section. ICD 420 is a Cell Phone equipped with a Camera and GPS capability. It is one type of information capture device (ICD) within the scope of the present invention. In other embodiments of the invention ICD 420 is any device capable of both transmitting information via email or other data transport and capturing or storing that information, information such as olfactory sensing data, sounds, GPS data, photographs or videos.

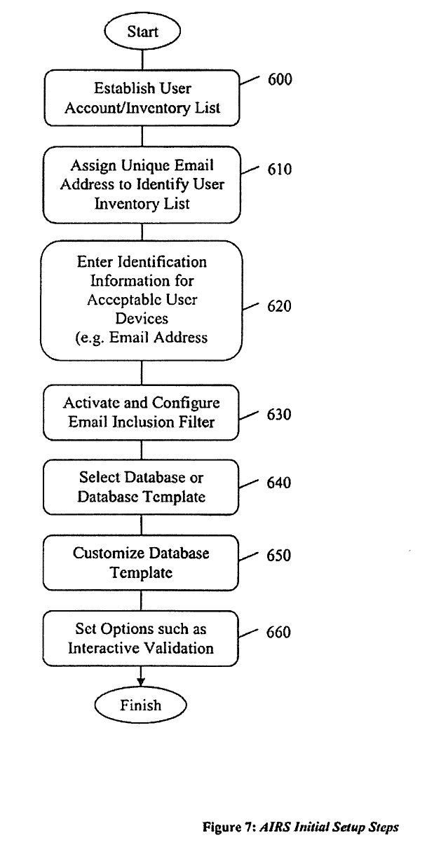

Again referring to FIG. 3, ICD 420 is equipped with both a camera and email capabilities. It is used to take a photograph of Item 410 and transmit that photograph via Communications Network 430 to IAD 440 using a unique email address, something like “user 1@airsserver.com” that is a proxy for and corresponds to a specific user's inventory list and was created during initial service setup. Initial service setup is illustrated in FIG. 7 and will be discussed later in this section. Within the scope of the present invention one option to a unique email address is to use a shared email address, something like “inventory@airsserver.com” that is not assigned to a single user but rather is shared by multiple users of the service enabled by the present invention. In the shared-email-address embodiment of the present invention the user and the user's specific inventory list is identified by other information contained in the email transmission, or other data transport protocol, such as the sender's email address in the “From” field, special pre-defined content in the “Subject” field, MIN, ESN, IP address or similar identification information.

Returning to FIGS. 3 and 8, IAD 440 is a server that hosts the Automated Inventory Recording System (AIRS) program. AIRS in this hosted embodiment has its own domain, for example airsserver.com, an embodiment that is especially suitable for a business model where a new company is formed to provide a service based on the present invention directly to users. In another business model, for example an existing banking corporation wants to add a personal inventory service using this invention to its customers and already has its own domain, the AIRS application would likely tie in and use that corporations' existing domain. Building on the banking corporation example, assume the bank's domain name was “greatbankcorporation.com”, a possible unique email address with the present invention would be “inventoryuser1@greatbankcorporation.com”. Likewise, a possible shared email address in this banking corporation scenario would be “personalinventory@greatbankcorporation.com”. In another embodiment of this invention, referred to as a stand-alone or home-based embodiment, LAD 440 would be a personal or business computer loaded with the AIRS program but supporting just a single user or a limited number of users. In this stand-alone embodiment a separate domain is not required and although a unique email address is desirable in this situation the use of email information fields such as “From” and “Subject” information could be used in place of establishing a unique email address to exclusively correspond to a single user inventory list. User Access Device (UAD) 460 is typically, though not exclusively, a personal computer equipped with a web browser. UAD 460 interacts with AIRS on LAD 440 via the Communications Network 430. In the server embodiment depicted in FIGS. 3 and 8, 460 is the means by which service is initiated and set up as well as one means by which a user retrieves or receives list and record information, represented by User Inventory List 450, from AIRS. In other embodiments of the present invention AIRS would effect a copy of the user's list be sent to the user via email, non-electronically such as traditional mail or via some other communications medium, without necessarily any specific prompting from the user. In a stand-alone embodiment of the present invention, IAD 440 and User Access 460 would be the same computer and User Access 460 would not require a Communications Network 430 to interact with the AIRS application. The user would interact directly with the AIRS program. A list is a collection of one or more records generated with the AIRS program resident on 440. User Inventory List 450 is a representation of how a list might be organized and presented. There is nothing exclusive, unique or critical to the present invention inherent in the format, fields, programming or appearance of 450. It is shown to illustrate the invention's automatic generation of a listed record using a transmitted information object, in this illustration a photograph of an item, which is in turn represented in the illustration as a string of pearls, to any type of database program capable of including photographs as part of a record or as a table entry. It also demonstrates that programming within ICD 420 to enable packaging of GPS information along with the email transmission of the photograph, combined with complimentary programming within IAD 440 to extract that GPS information enables the present invention to automatically create a database record that includes a photograph of an item, the date and time the photograph was taken and the location of the item when the photograph was taken (450). Other pieces of information regarding an item that it may be desirable to record are indicated with the “Value” and “ . . . ” columns shown in 450. All columns shown represent types of information that can be included in a soft vare record not required pieces of information within the context of the present invention.

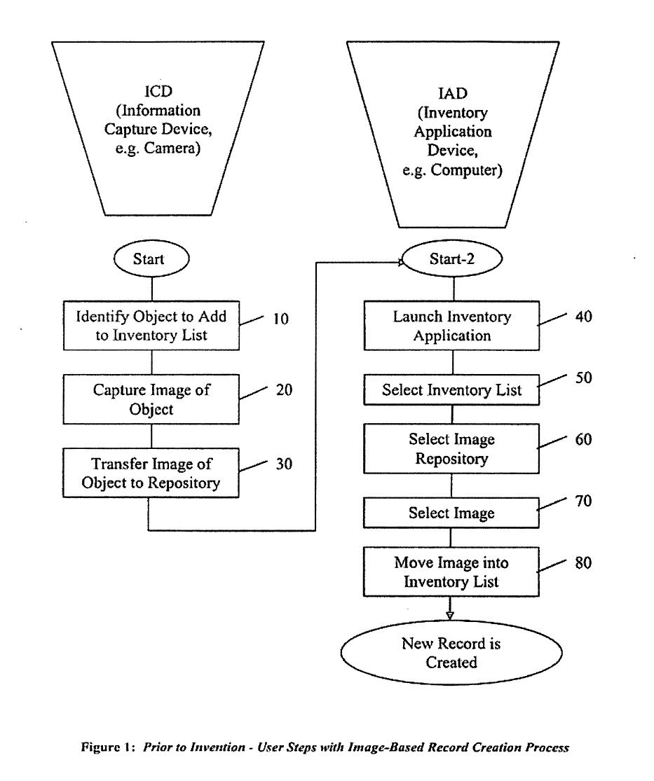

FIG. 1 illustrates the process of creating a software record incorporating image information prior to the present invention. The present invention is not limited to the capture and recording of images but applies to any information that can be captured and stored on a computer, including recorded sounds and olfactory sensing data, and transmitted in an email attachment. In the prior art process depicted in FIG. 1 the user directly manipulates two devices, an information capture device (ICD) such as a digital camera and an inventory application device (IAD), which is a computer equipped with inventory application software such as “Home Contents Inventory List” (http://office.microsoft.com/en-us/templates/CT101172541033.aspx?av=ZXL000) or Liberty Street Software's AssetManage Home Inventory Software (www.libertystreet.com/Asset-Home-Inventory.htm). Steps 10, 20, 30, 40, 50, 60, 70 and 80 illustrate the four primary decisions a user must make and the seven actions a user performs in the process of creating a listed record Steps 10, 50, 60 and 70 are decision points. Steps 20, 30, 40, 50, 60, 70 and 80 require the user to physically interact with the relevant device. Steps 10, 20 and 30 are associated with the ICD, a camera in this illustration. In step 10 the user decides what item will be added to the user's inventory list. In step 20 a camera is used to take a photograph of the item decided on in step 10. Transfer of the photograph to a repository accessible by the LAD is shown as step 30. The process now moves to the second device, the IAD, which is a computer on which has been loaded or programmed an inventory application. The IAD and the inventory application are powered on by the user in step 40. Within the inventory application a new list for storing records must be created or an existing list selected. The user does this in step 50. After the correct inventory list is chosen the user decides in step 60 where the desired photograph of the item to be inventoried is located and accesses that location via the inventory application. After accessing the repository where the desired photograph is located the user finds and selects the photograph, step 70, and in step 80 moves or copies that image into the user's previously opened inventory list, step 50, thereby creating a new record that includes the image. The new record may be image-based or simply a new record that includes the image.

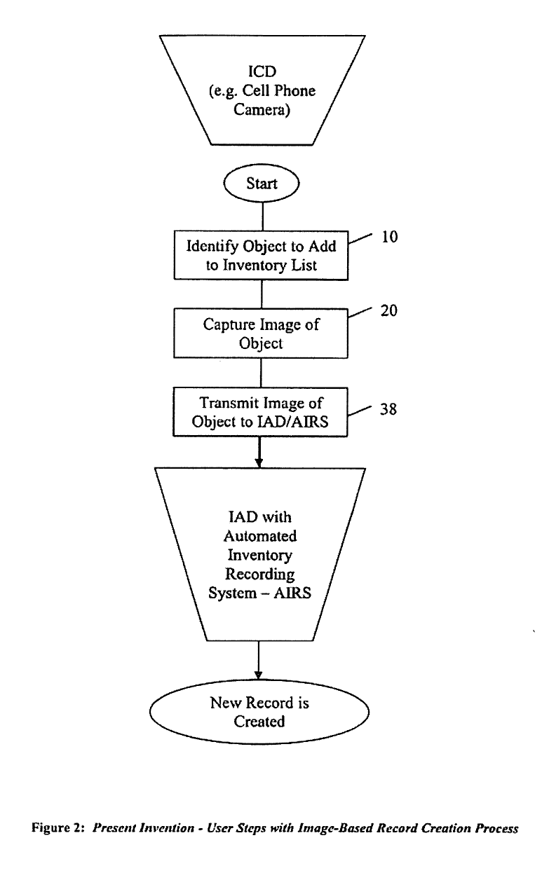

FIG. 2 illustrates the process of creating a software record incorporating image information with the present invention. The reduction in decision and action steps to three from the eight steps illustrated in FIG. 1 demonstrates one of this invention's key benefits. Additional benefit is evident in that creating a software record utilizing the present invention requires the user to directly manipulate just a single device, the ICD, not two or more devices as with prior-art inventory systems. Note that the ICD in this embodiment of the present invention is both a camera and a communications device that is capable of emailing images. A typical example of such a device is a cell phone equipped with a camera with service from a wireless service provider such as Sprint or Verizon. Also note that in instances where records incorporate representational images as opposed to captured actual images the ICD can be any device capable of attaching images to an email message and emailing that message. With the present invention the user is not required to directly interact with the IAD or to operate the inventory application resident therein in order to create a record of an item. That part of the record creation process is fully automated. In addition, the need for and use of image and other repositories to store recorded information, information used to identify or help define inventory items and intended to be used to create a software record, is eliminated. Steps 10 and 20 in FIG. 2 are identical to steps 10 and 20 in FIG. 1. In step 10 the user decides what item will be added to the user's inventory list. In step 20 a camera is used to take a photograph of the item decided on in step 10. Step 38 in FIG. 2 highlights a key component of the present invention which is the transmission itself contains sufficient information to not only route the information object, in this embodiment an image, to the desired physical location, a specific LAD, but the transmission itself also contains or represents sufficient information to cause it to be directed to a logical location, such as a specific software application, and most significantly the transmission itself conveys sufficient information to indicate that the information contained therein is for a specific list or table within a software application. For example, in the preferred embodiment transmission is via email. In this email embodiment an email address not only serves to accurately route the information object to a location, an IAD, but that same email address serves as both a proxy for a software application and corresponds to a specific user list within that application. In this illustration the user transmits an image, a photograph, directly to the IAD. The IAD is equipped with a software program herein referred to as the Automated Inventory Recording System (AIRS) program. AIRS receives the email with the attached image, uses the proxy address, or in other embodiments different transport information, to determine the user listing in which a new record should be created, and then uses the image within the email to create that new record.

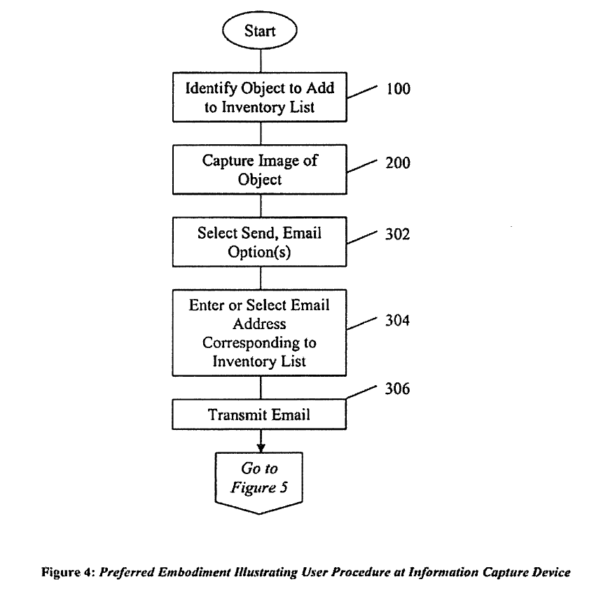

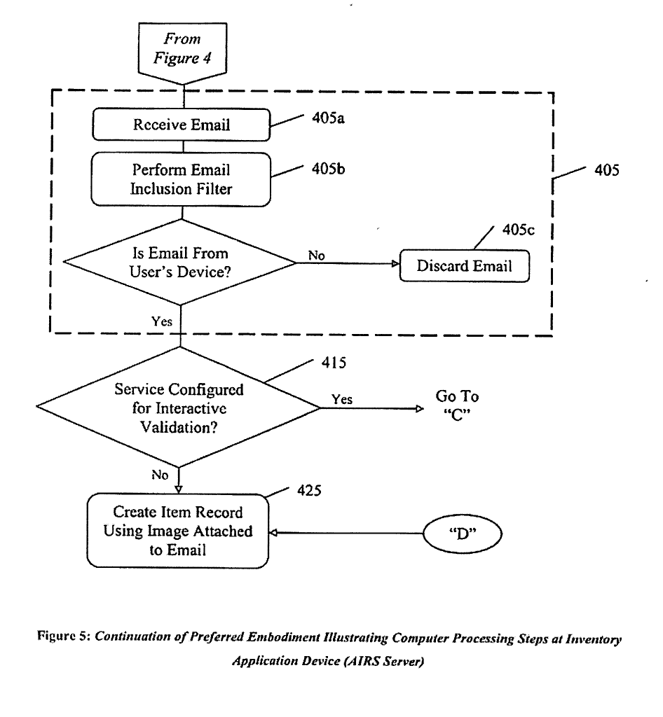

FIGS. 4, 5, 6 and 7 illustrate one embodiment of the invention. Starting with FIG. 4 which shows the process at the ICD, a user decides to add an object to an inventory list (100). The object may be any type of software recordable information or computer data used to identify, describe or define an item. In this embodiment the object is an image, a photograph of the item the user desires to record in an inventory list. The user captures the image by taking its photograph using any of a variety of wireless devices equipped with a camera and having the ability to transmit images (200). Transmission of the object in this embodiment of the invention is via email therefore the wireless device is operated to send the photograph via email (302). In other embodiments transmission is via other communications protocols. During service setup either a unique email address corresponding to the user's inventory list or a shared email address corresponding to the inventory application program within AIRS was established. Using an email address as a proxy for and to correspond to a specific user list or specific software program is one means of implementing the invention. Alternative means such as a menu selection programmed into a device, utilizing an IP address, IP or UDP port number, mobile identification number (MIN), electronic serial number (ESN) or the like, available with protocols other than email (i.e. SMTP), are also viable and highlight other embodiments of the present invention. In the preferred, email embodiment illustrated, after selecting the wireless device's email option the user either selects the previously stored proxy email address corresponding to the desired inventory list, perhaps stored in the ICD's contact list under a name such as ‘Home Inventory’, or enters that proxy email address (304). With the use of alternative protocols the wireless device or wireless service could include a menu option such as “Send to Home Inventory” in addition to the currently available options (e.g. Sprint's Sanyo Katana cell phone menu options for photographs include: Send, Upload, and Prints by Mail) and the user would select the “Send to Home Inventory” option instead of the send, email option. In the illustrated embodiment of FIG. 4 the photograph has been attached to the email within the wireless device and is now transmitted via email to the IAD where the AIRS program resides (306). The email transmitted in step 306 of FIG. 4 is received at the IAD in FIG. 5 by the email server component (405) of the AIRS program. Receiving email (405a), inclusion-list filtering (405b), and deleting filtered email (405c) are processes well understood by those skilled in the art. In embodiments of the present invention that do not utilize email as the means of transporting information objects, 405 is a comparably functioning component suitable for the communications protocol that is used. The present invention's ability to identify only the specific ICD permitted to submit objects to a user's item list prevents unwanted records from being created. Information to identify the permissible ICD is collected and stored during initial service set up (see discussion below especially regarding 620 in FIG. 7). Configuration of email server 405 includes the optioning of the inclusion list with this ICD identification information. In the present embodiment of the invention, where email transmission is utilized, the data that identifies a permissible ICD is the user's normal email address from which the user transmits messages. Typically this is the user's personal email address; however, it can be any email address dedicated to the user and identified by the user during initial service set up as the sole device(s) from which information objects can be accepted. In other embodiments utilizing alternative transport protocols instead of email the ICD identification could be a MIS, ESN, IP address or other device identifier included in the transmission protocol. Consequently, using inclusion-list or similar filtering process combined with a unique email address the present invention restricts data submission to a software application thereby preventing or greatly mitigating false record entries. During service set up the user may opt for interactive validation, meaning the user wants to check each email leaving the email subsystem (405) prior to the object being processed to create all item record. The present invention determines if the validation option was selected (415). If validation was not selected the object(s) attached to the email, in this illustration a photographic image, is detached, the inventory database application within AIRS is opened or accessed, the user's specific list within that application is opened and the detached object is used to create a new record within the list (425). As noted previously, those skilled in the art will understand how a database functions and the various means of programming available to accomplish the operations of 425.

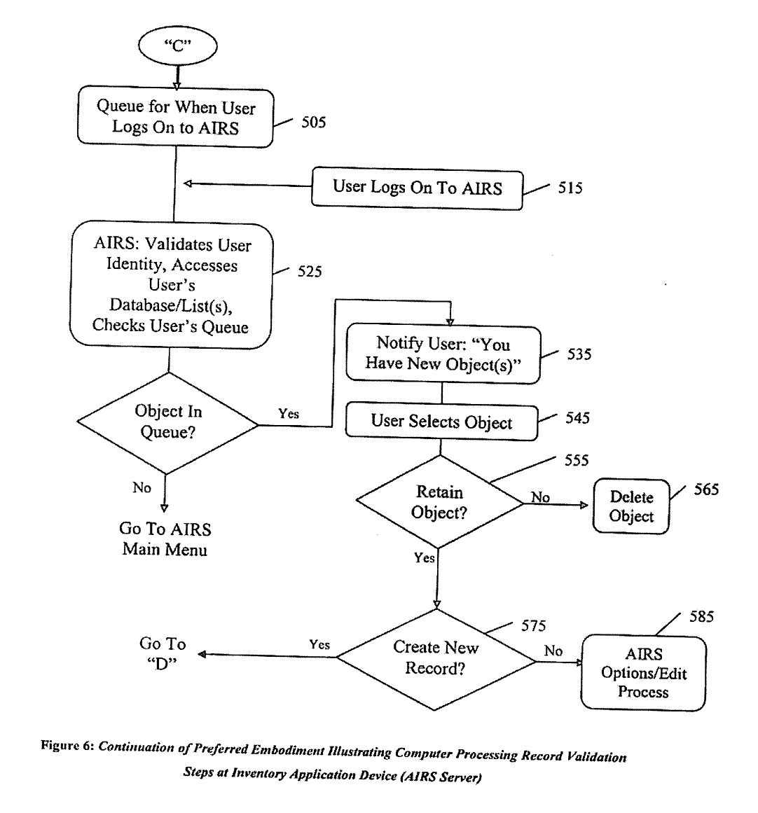

If during service set up validation is selected, the email is queued (505 in FIG. 6) until such time as the user directly accesses IAD 440 and the resident AIRS program via UAD 460 (515). Upon user access the present invention checks the user's queue (525) and on confirming an object, in this embodiment an email, is present the invention notifies the user (535). If there are multiple objects in queue the invention prompts the user to make a selection (545), decide if the object should be retained (555), and if retained whether the object should be used to create a new record or to be otherwise processed (575). If the user confirms a new record should be generated the process returns to 425. If the user decides the object should not be used to generate a new record but wants it for other purposes, for example to add that object to an existing record, then the object is handled otherwise (585).

FIG. 7 illustrates the initial service set up process for the email-embodiment of the present invention. On initial access, whether upon accessing the AIRS Server (440) for the first time in the hosted embodiment or loading the AIRS program on the user's computer (460 plus 440) in a stand-alone/home-based embodiment and launching it for the first time, the invention registers the user and initiates a database list that is aligned with the user (600). In the server/hosted embodiment the service provider, reflected by IAD 440, has its own domain (e.g. airsserver.com) and the invention generates a unique email address, e.g. user1@airsserver.com, as a proxy for and corresponding to the database list associated with the user (610). Alternatively, a shared email address, e.g. inventory@airsserver.com, combined with another identifier such as the user's personal email address can be used to correspond to the user's database list. In the stand-alone/home-based embodiment the AIRS program assists the user in setting up a new unique email address with the user's email service provider. For example, many ISPs provide for at least 5 email addresses for personal or home use. Assuming the user has not used all five addresses the user can readily open a new email address specifically for the AIRS application and to correspond to the user's inventory list. A data base manager, residing as a software component within AIRS, maintains and manages the proxy email addresses corresponding to user lists that are stored on the AIRS database. As just discussed, at service set up the AIRS database generates a proxy email address that represents the corresponding user list. This database also stores acceptable-user-device identification information corresponding to each proxy email address. Acceptable-user-device identification information, in the illustrated embodiment the user's regular email address from which the user will transmit objects to be added to the user's inventory list, is collected (620) and used to configure the inclusion filter (405b) within the email server component of AIRS to ensure that only user-selected information is stored and recorded (630). With the server/hosted embodiment the email server is resident within the AIRS server and therefore activation and configuration of the inclusion filter is less complex than with the stand-alone/home-based embodiment where different email clients and email servers must be navigated in order to perform the same activation and configuration. However, the means of performing this step is apparent to those familiar with email systems and programming. As with most database systems, the present invention permits use of various databases and database templates (640) as well as customization of a selected database template (650). Although most installations of the present invention will embed a database application within the AIRS program there will be instances where AIRS incorporates a non-resident database application, where the inventory database is external to 440. The final step in the set up process is to select options; most notably the user must decide whether or not interactive validation is activated (660).

What I claim as my invention is:

1. A method of automatically creating computer software records from information objects (e.g. image, sound recording, text, odor sensing data) transmitted over a communications network, notably but not exclusively records that include images that were transmitted within an email

2. A method as set forth in claim 1 that eliminates the need for a user to initiate the creation of a software record from within a computer program that generates, stores and manages records

3. A method as set forth in claim 1 that reduces the number of devices a user must interact with in order to generate a new record within a software program to a single device

4. A method as set forth in claim 1 that eliminates redundant decision points in selecting information used within a software record

5. A method as set forth in claim 1 that enables the direct transfer and storage of information objects into databases and other data-storage systems thereby eliminating the need for and use of repositories, such as image folders and photograph libraries, as intermediate storage points

6. A method as set forth in claim 1 wherein a unique email address is a proxy for and corresponds to a specific table or list within a database or similar data-storage application

7. A method as set forth in claim 1 wherein a shared unique email address is a proxy for and corresponds to a specific application program, such as a database program

8. A method as set forth in claim 1 wherein “to” and “from” email address information is used to automatically route information objects (e.g. image, sound recording, text, odor sensing data), or similar computer data, to specific lists or tables within a database or similar data-storage application

9. A method as set forth in claim 1 wherein transmission to a unique email address specifies an information object (e.g. image, sound recording, text, odor sensing data) or similar computer data belongs within a specific software application such as a database or spreadsheet program

10. A method as set forth in claim 1 wherein transmission to a unique email address specifies an information object (e.g. image, sound recording, text, odor sensing data) or similar computer data belongs within a specific table, list, spreadsheet or similar computer program

11. A method as set forth in claim 1 wherein a proxy email address is used to automatically route and submit emailed information objects (e.g. image, sound recording, text, odor sensing data) or similar computer data to a database or other computer program

12. A method as set forth in claim 1 wherein a proxy email address is used to route and automatically submit information objects (e.g. image, sound recording, text, odor sensing data) or similar computer data to a specific database table, specific database list, specific spreadsheet or similar data-storage

13. A method as set forth in claim 1 of receiving within a software application program transmitted information objects (e.g. image, sound recording, text, odor sensing data) or similar computer data from only a defined, limited set of remote devices thereby facilitating the exclusion of inappropriate and unwanted entries

14. A method of claim 13 wherein inclusion list filtering blocks unwanted record entries

15. A method as set forth in claim 1 further including a method of collecting, temporarily storing and queuing information objects (e.g. image, sound recording, text, odor sensing data) to permit validation or other processing prior to record creation

16. A system and apparatus for automatically generating software records from transmitted information, notably but not exclusively images emailed from a camera-equipped wireless device, said system and apparatus comprising:
a. An inventory application device which is a computer equipped with email server functions, web server functions, database management and databases and programming that integrates these components to effect the generation and use of unique email addresses as proxies for and to correspond to specific tables or lists within a database or similar application and to cause a new software record to be generated in the correct table or list on receiving emails from only previously defined and identified devices or users to said unique email addresses
b. An information capture device which is any device capable of capturing or storing information such as images, olfactory sensing data, sounds and GPS and transmitting that information via email to a proxy email address
c. A communications network over which emails containing information objects can be transmitted to a proxy email address
d. A user access device which is typically a personal computer but may also be a device equipped with a web browser

17. A system and apparatus of claim 16 wherein:
a. The inventory application device employs a transmission protocol interpreter instead of email server functions; device identification other than email address, such as MIN, ESN or IP address; and a programmed menu or a proxy scheme that uses a fixed IP address, URL or similar means other than a unique email address, to route information objects and correspond to a specific database table or specific record-generating software application
b. The information capture device is any device capable of capturing or storing information such as images, olfactory sensing data, sounds and GPS and transmitting that information via protocols that include some form of device identification with the transmission
c. The communications network is any network over which information objects can be transmitted

18. A system as set forth in claim 16 with two (2) architectural embodiments:
a. A server/hosted embodiment
b. A stand-alone/home-based embodiment
